(19) United States
(12) Patent Application Publication
(10) Pub. No.: US 2025/0206635 A1
(43) Pub. Date: Jun. 26, 2025

(54) METHOD FOR PREPARING LITHIUM-ION BATTERY CATHODE MATERIAL

(71) Applicant: NAN YA PLASTICS CORPORATION, TAIPEI (TW)

(72) Inventors: TE-CHAO LIAO, TAIPEI (TW); HUNG-YI CHANG, TAIPEI (TW); WEI-SHENG CHENG, TAIPEI (TW); WEN-TA CHENG, TAIPEI (TW); NEI-MEI FANG, TAIPEI (TW)

(21) Appl. No.: 18/595,307

(22) Filed: Mar. 4, 2024

(30) Foreign Application Priority Data
Dec. 25, 2023 (TW) 112150482

(51) Int. Cl. C01G 53/00; H01M 4/505; H01M 4/525

(52) U.S. Cl. CPC C01G 53/44; H01M 4/505; H01M 4/525; C01P 2006/40

(57) ABSTRACT

A method for preparing a lithium-ion battery cathode material includes implementing a Couette-Taylor reaction operation and a calcining operation. The Couette-Taylor reaction operation includes feeding a first reaction liquid and a second reaction liquid into a Couette-Taylor reactor to form a product stream including a cathode material precursor. The first reaction liquid is a multi-metal solution containing a nickel compound, a cobalt compound, and a manganese compound. The second reaction liquid is a lithium source metal solution containing a lithium compound. The cathode material precursor contains lithium elements. The calcining operation includes using a high-temperature tubular furnace to calcine the cathode material precursor to obtain the lithium-ion battery cathode material.

### CROSS-REFERENCE TO RELATED PATENT APPLICATION

This application claims the benefit of priority to Taiwan Patent Application No. 112150482, filed on Dec. 25, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for preparing a cathode material, and more particularly to a method for preparing a lithium-ion battery cathode material.

### BACKGROUND OF THE DISCLOSURE

Nickel-rich ternary/quaternary cathode materials are currently popular for lithium-ion battery cathodes due to their high energy density and low cost. The preparation method of the cathode materials includes synthesizing cathode material precursor using co-precipitation, followed by uniform mixing of the cathode material precursor with a lithium salt, and then sintering the cathode material precursor mixed with the lithium salt under a high-temperature solid-phase, so as to obtain the cathode material. However, the above process is quite complex, such as to involve high preparation costs.

Currently, a primary method for mixing the lithium salt with the cathode material precursor is a solid-solid grinding method, which includes placing the lithium salt into a ball mill for milling, and then mixing the milled lithium salt with the cathode material precursor in a mixer according to a predetermined ratio before sintering.

Due to significant differences in specific gravity and particle size between the lithium salt and the cathode material precursor, uniform mixing of the materials through the solid-solid grinding method is difficult and leads to localized lithium-rich or localized lithium-deficient areas in a sintered oxide, resulting in poor electrochemical performance and poor batch-to-batch stability of the product.

### SUMMARY OF THE DISCLOSURE

In response to the above-referenced technical inadequacies, the present disclosure provides a method for preparing a lithium-ion battery cathode material, and the method enables the lithium-ion battery cathode material to have uniformly dispersed lithium elements.

In order to solve the above-mentioned problems, one of the technical aspects adopted by the present disclosure is to provide a method for preparing a lithium-ion battery cathode material.

The method includes implementing a Couette-Taylor reaction operation and a calcining operation. The Couette-Taylor reaction operation includes feeding a first reaction liquid and a second reaction liquid into a Couette-Taylor reactor to react with each other, so as to form a product stream including a cathode material precursor. The first reaction liquid is a multi-metal solution containing: a nickel compound, a cobalt compound, and a manganese compound. The second reaction liquid is a lithium source metal solution containing a lithium compound, and the cathode material precursor contains lithium elements. The calcining operation includes using a high-temperature tubular furnace to calcine the cathode material precursor separated from the product stream to obtain the lithium-ion battery cathode material.

In one of the possible or preferred embodiments, after the Couette-Taylor reaction operation and before the calcining operation, the method further includes: implementing a purification operation. The purification operation includes filtering and drying the product stream to separate out the cathode material precursor in a powder form.

In one of the possible or preferred embodiments, in the second reaction liquid, the lithium compound is at least one of lithium hydroxide (LiOH), lithium carbonate (Li₂CO₃), lithium acetate (CH₃COOLi), lithium oxalate (Li₂C₂O₄), lithium sulfate (Li₂SO₄), and lithium nitrate (LiNO₃).

In one of the possible or preferred embodiments, in the first reaction liquid, the nickel compound is nickel sulfate (NiSO₄), the cobalt compound is cobalt sulfate (CoSO₄), and the manganese compound is manganese sulfate (MnSO₄). Further, in the second reaction liquid, the lithium compound is lithium hydroxide (LiOH).

In one of the possible or preferred embodiments, the lithium compound in the second reaction liquid is a source of the lithium elements of the cathode material precursor.

In one of the possible or preferred embodiments, in the Couette-Taylor reaction operation, the second reaction liquid is configured to regulate a pH value of a reaction mixture including the first reaction liquid and the second reaction liquid, in which the pH value of the reaction mixture is adjusted to be between 10 and 12.

In one of the possible or preferred embodiments, in the Couette-Taylor reaction operation, the second reaction liquid does not contain sodium hydroxide (NaOH).

In one of the possible or preferred embodiments, the Couette-Taylor reaction operation further includes: feeding a chelating agent liquid into the Couette-Taylor reactor to mix with the reaction mixture. The chelating agent liquid is an ammonia solution.

In one of the possible or preferred embodiments, a first reaction liquid flow rate of the first reaction liquid fed into the Couette-Taylor reactor is between 1.5 mL/min and 2.0 mL/min, a second reaction liquid flow rate of the second reaction liquid fed into the Couette-Taylor reactor is between 2.3 mL/min and 3.0 mL/min, and a flow rate ratio between the first reaction liquid flow rate and the second reaction liquid flow rate is between 1:1.2 and 1:2.

In one of the possible or preferred embodiments, the cathode material precursor formed by the Couette-Taylor reaction operation is a hydroxide of a metal alloy, and the metal alloy includes nickel elements, cobalt elements, manganese elements, and the lithium elements.

In one of the possible or preferred embodiments, calcining conditions of the calcining operation include filling an oxygen gas into the high-temperature tubular furnace and heating the oxygen gas to a first temperature of 120° C. to 180° C. to heat the cathode material precursor for 1 hour to 3 hours; and then, heating the oxygen gas to a second temperature of 450° C. to 550° C. to heat the cathode material precursor for 5 hours to 7 hours; and then, heating the oxygen gas to a third temperature of 750° C. to 850° C. to heat the cathode material precursor for 11 hours to 13 hours, so as to finally form the lithium-ion battery cathode material.

In one of the possible or preferred embodiments, after the Couette-Taylor reaction operation and before the calcining operation, the method does not include steps of mixing and ball milling the cathode material precursor with a solid lithium salt.

Therefore, in the method for preparing the lithium-ion battery cathode material provided by the present disclosure, by virtue of “implementing a Couette-Taylor reaction operation including: feeding a first reaction liquid into a Couette-Taylor reactor, in which the first reaction liquid is a multi-metal solution containing: a nickel compound, a cobalt compound, and a manganese compound; feeding a second reaction liquid into the Couette-Taylor reactor to react with the first reaction liquid to form a product stream including a cathode material precursor, in which the second reaction liquid is a lithium source metal solution containing a lithium compound, and the cathode material precursor contains lithium elements,” and “implementing a calcining operation including using a high-temperature tubular furnace to calcine the cathode material precursor separated from the product stream to obtain the lithium-ion battery cathode material,” lithium elements can be uniformly dispersed at an atomic level in the cathode material by introducing the lithium source (i.e., the lithium source metal solution) through the co-precipitation method, thereby reducing a degree of cation mixing and enhancing an orderliness of a layered structure of the cathode material.

In addition, the cathode material has uniform particle size, which can improve battery life and stability. Meanwhile, on the basis of achieving high gram capacitance and good capacitance maintenance rate, the cathode material is also safe.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a system using a Couette-Taylor reactor for preparing a cathode active material precursor according to an embodiment of the present disclosure; and

FIG. 2 is a flow chart showing a method for preparing a lithium-ion battery cathode active material according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [Method for Preparing Lithium-ion Battery Cathode Material]

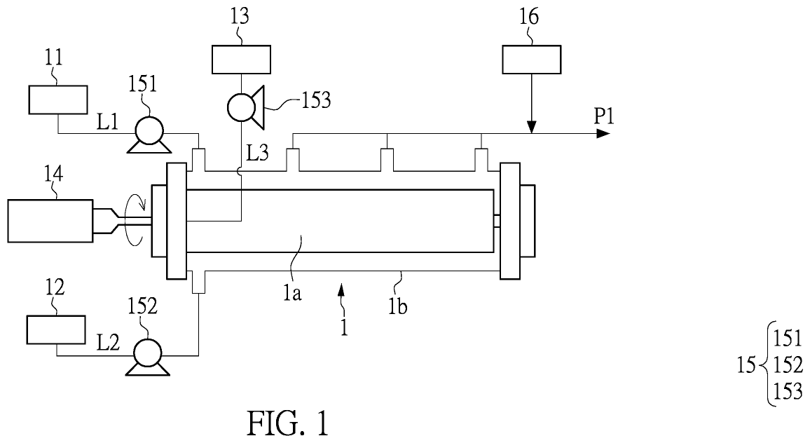

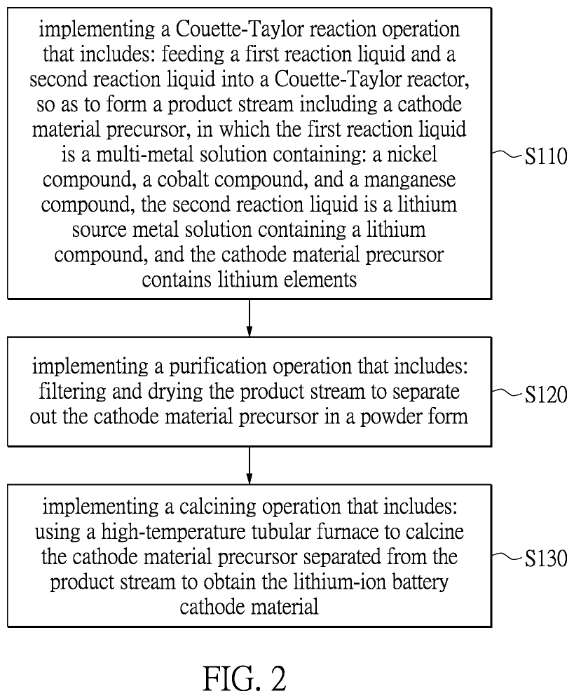

Referring to FIG. 1 and FIG. 2, an embodiment of the present disclosure provides a method for preparing a lithium-ion battery cathode material. The method includes using a Couette-Taylor reactor to prepare a cathode material precursor (i.e., cathode active material precursor), and the cathode material precursor contains lithium elements.

Subsequently, the cathode material precursor, which contains the lithium elements, is directly subjected to a calcining operation. The cathode material precursor can be directly formed into a lithium-ion battery cathode material without being mixed with additional lithium salt.

The method provided by the embodiment of the present disclosure enables the lithium elements to be dispersed in the lithium-ion battery cathode material at an atomic level, so as to improve the situation of local lithium-rich or local lithium-deficient in the conventional art, thereby improving endurance and stability of a lithium-ion battery.

More specifically, the method for preparing the lithium-ion battery cathode material includes Step S110, Step S120, and Step S130.

Step S110 is to implement a Couette-Taylor reaction operation that includes: feeding a first reaction liquid L1 into a Couette-Taylor reactor 1 (e.g., a laminar continuous Taylor reactor ‘LCTR) through a first reaction liquid supply unit 11, and simultaneously feeding a second reaction liquid L2 into the Couette-Taylor reactor 1 through a second reaction liquid supply unit 12, so as to perform a co-precipitation reaction, thereby forming a product stream P1 including a cathode material precursor, in which the cathode material precursor contains lithium elements.

The first reaction liquid L1 is a multi-metal solution.

The multi-metal solution contains a nickel (Ni) compound, a cobalt (Co) compound, and a manganese (Mn) compound. In some embodiments of the present disclosure, the multi-metal solution further includes: at least one of a magnesium (Mg) compound and an aluminum (Al) compound.

For example, the multi-metal solution can be a nickel-cobalt-manganese ternary-metal solution, a nickel-cobalt-manganese-magnesium quaternary-metal solution, or a nickel-cobalt-manganese-aluminum quaternary-metal solution, but the present disclosure is not limited thereto.

In some embodiments of the present disclosure, the nickel compound can be nickel sulfate (NiSO₄), the cobalt compound can be cobalt sulfate (CoSO₄), the manganese compound can be manganese sulfate (MnSO₄), the magnesium compound can be magnesium sulfate (MgSO₄), and the aluminum compound can be aluminum sulfate (Al₂(SO₄)₃), but the present disclosure is not limited thereto.

The second reaction liquid L2 is a lithium source metal solution that contains a lithium (Li) compound.

In some embodiments of the present disclosure, the lithium compound is at least one of lithium hydroxide (LiOH), lithium carbonate (Li₂CO₃), lithium acetate (CH₃COOLi), lithium oxalate (Li₂C₂O₄), lithium sulfate (Li₂SO₄), and lithium nitrate (LiNO₃).

Preferably, the lithium compound is lithium hydroxide (LiOH).

The second reaction liquid L2 contains a lithium (Li) compound, which serves as the source of lithium elements for the cathode material precursor in the reaction system. Furthermore, the lithium (Li) compound of the second reaction liquid L2, such as lithium hydroxide, can act as a precipitating agent, which can replace the use of a conventional precipitating agent (e.g., sodium hydroxide, NaOH). The lithium compound can be used to adjust a pH value of the reaction mixture that contains the first reaction liquid L1 and the second reaction liquid L2. The pH value of the reaction mixture is preferably adjusted to 10 to 12, and more preferably 10.5 to 11.5.

Overall, the embodiment of the present disclosure provides a method for preparing a lithium-ion battery cathode material. The method adopts a Couette-Taylor reactor to prepare a cathode material precursor. During a preparation process of the cathode material precursor, a lithium compound is mixed and co-precipitated with the metal salts, such as a nickel salt, a cobalt salt, and a manganese salt, so as to form the cathode material precursor.

Additionally, the multi-metal solution containing the elements, such as nickel, cobalt, and manganese, can be used to form nuclei of the multi-metal precursor, followed by introducing the lithium source metal solution into the multi-metal precursor to prepare the lithium-ion battery cathode material.

The method of the embodiment of the present disclosure introduces the lithium source through the co-precipitation method, enabling the lithium elements to be uniformly dispersed at an atomic level, thereby reducing a degree of cation mixing and enhancing an orderliness of a layered structure of the cathode material.

Furthermore, the cathode material has uniform particle size, which can improve battery life and stability. Meanwhile, on the basis of achieving high gram capacitance and good capacitance maintenance rate, the cathode material is also safe.

More specifically, the Couette-Taylor reactor 1 includes a rotation axis 1a and a reaction chamber 1b that surrounds the rotation axis 1a along a radial direction.

The first reaction liquid supply unit 11, the second reaction liquid supply unit 12, and a chelating agent supply unit 13 are respectively connected to an initial position of the Couette-Taylor reactor 1 (e.g., a left end portion of the Couette-Taylor reactor 1 as shown in FIG. 1).

The Couette-Taylor reactor 1 further includes a rotation motor 14 connected to the rotation axis 1a along the axial direction, and the rotation motor 14 is configured to drive the rotation axis 1a to rotate along the axial direction. The first reaction liquid supply unit 11 is configured to feed the first reaction liquid L1 (e.g., the nickel-cobalt-manganese ternary metal solution) into the reaction chamber 1b of the Couette-Taylor reactor 1 through a liquid delivery unit 151 of a pump module 15.

The second reaction liquid supply unit 12 is configured to feed the second reaction liquid L2 (e.g., the lithium source metal solution) into the reaction chamber 1b of the Couette-Taylor reactor 1 through another liquid delivery unit 152 of the pump module 15, so as to form a reaction mixture and perform a co-precipitation reaction in the reaction chamber 1b.

The chelating agent supply unit 13 is configured to feed a chelating agent liquid L3 (e.g., an ammonia aqueous solution, NH₄OH (aq.)) into the reaction chamber 1b of the Couette-Taylor reactor 1 to mix with the reaction mixture containing the first reaction liquid L1 (e.g., the nickel-cobalt-manganese ternary metal solution) and the second reaction liquid L2 (e.g., the lithium source metal solution) through still another liquid delivery unit 153 of the pump module 15. Accordingly, the chelating agent liquid L3 is chelated with the metal elements (e.g., nickel, cobalt, manganese, and lithium).

The rotation motor 14 is configured to drive the rotation axis 1a to rotate along the axial direction, so that the reaction mixture, which is formed of the first reaction liquid L1 (e.g., the multi-metal solution), the second reaction liquid L2 (e.g., the lithium source metal solution), and the chelating agent liquid L3 (e.g., the ammonia aqueous solution) that are fed into the reaction chamber 1b of the Couette-Taylor reactor 1, can be mixed uniformly and reacted completely.

The cathode material precursor formed from the Couette-Taylor reaction operation has the lithium elements dispersed therein, and the lithium elements are uniformly distributed at an atomic level within the cathode material precursor.

In the Couette-Taylor reaction operation, a rear side of an outlet of the Couette-Taylor reactor 1 (e.g., the rear side of the right end of the Couette-Taylor reactor 1 as shown in FIG. 1) is connected to a pH value monitoring unit 16 to monitor a pH value of the product stream P1 containing the cathode material precursor.

In some embodiments of the present disclosure, in order to enhance reaction efficiency of the Couette-Taylor reaction operation, a reaction temperature of the Couette-Taylor reactor 1 is between 50° C. and 70° C., and preferably between 55° C. and 65° C.

A rotation speed at which the rotation motor 14 drives the rotation axis 1a to rotate is between 500 rpm and 700 rpm, and preferably between 550 rpm and 650 rpm.

A first reaction liquid flow rate of the first reaction liquid L1 (e.g., the multi-metal solution) fed into the reaction chamber 1b of the Couette-Taylor reactor 1 through the first reaction liquid supply unit 11 is between 1.5 mL/min and 2.0 mL/min, and preferably between 1.6 mL/min and 1.8 mL/min.

Further, a second reaction liquid flow rate of the second reaction liquid L2 (e.g., the lithium source metal solution) fed into the reaction chamber 1b of the Couette-Taylor reactor 1 through the second reaction liquid supply unit 12 is between 2.3 mL/min and 3.0 mL/min, and preferably between 2.5 mL/min and 2.7 mL/min, which is higher than the first reaction liquid flow rate, so as to provide a sufficient lithium source. In addition, the second reaction liquid L2 (e.g., the lithium source metal solution) is configured to adjust the pH value of the reaction mixture to be between 10 and 12.

From another perspective, a flow rate ratio between the first reaction liquid flow rate and the second reaction liquid flow rate is between 1:1.2 and 1:2, and is preferably between 1:1.4 and 1:1.7.

A total volumetric molar concentration (moles/liter) of the multi-metal compounds (e.g., the nickel compound, the cobalt compound, and the manganese compound) in the first reaction liquid is between 1.5 M and 2.5 M, and preferably between 1.8 M and 2.2 M. In a specific embodiment, the multi-metal solution is an aqueous solution added with NiSO₄, CoSO₄, and MnSO₄ in a molar ratio of 8:1:1, and the total volumetric molar concentration of the multi-metal solution (NiSO₄, CoSO₄, and MnSO₄) is 2M.

A volumetric molar concentration of the lithium (Li) compound (e.g., lithium hydroxide) in the second reaction liquid is between 4.5 M and 5.3 M, and preferably between 5 M and 5.3 M.

A chelating agent flow rate of the chelating agent liquid L3 (e.g., the ammonia aqueous solution) fed into the reaction chamber 1b of the Couette-Taylor reactor 1 through the chelating agent supply unit 13 is between 0.4 mL/min and 0.8 mL/min, and preferably between 0.5 mL/min and 0.7 mL/min.

In addition, a residence time of the reaction mixture formed of the first reaction liquid L1 (e.g., the multi-metal solution), the second reaction liquid L2 (e.g., the lithium source metal solution), and the chelating agent liquid L3 (e.g., the ammonia solution) in the Couette-Taylor reactor 1 is between 172 minutes and 238 minutes, and preferably between 192 minutes and 217 minutes.

In the product stream P1, a weight average particle diameter (D50) of the cathode material precursor containing the lithium elements dispersed therein is between 5 micrometers and 15 micrometers, and preferably between 7 micrometers and 12 micrometers, but the present disclosure is not limited thereto.

The cathode material precursor is a hydroxide of a metal alloy composed of multiple metal elements and lithium elements.

In some embodiments, the cathode material precursor is a hydroxide of nickel (Ni)-cobalt (Co)-manganese (Mn)-lithium (Li) alloy, a hydroxide of nickel (Ni)-cobalt (Co)-manganese (Mn)-magnesium (Mg)-lithium (Li) alloy, or a hydroxide of nickel (Ni)-cobalt (Co)-manganese (Mn)-aluminum (Al)-lithium (Li) alloy, but the present disclosure is not limited thereto.

In the present embodiment, the position where the second reaction liquid supply unit 12 inputs the second reaction liquid L2 into the Couette-Taylor reactor 1 is radially symmetrical to the position where the first reaction liquid supply unit 11 inputs the first reaction liquid L1 into the Couette-Taylor reactor 1. Accordingly, the first reaction liquid L1 and the second reaction liquid L2 can be fully mixed with each other, but the present disclosure is not limited thereto.

It is worth mentioning that the above-mentioned process conditions are designed for a Couette-Taylor reactor having a volume of one liter (L), but the present disclosure is not limited thereto. The volume of the Couette-Taylor reactor can be enlarged to 10 liters to 1000 liters for reaction, and the process conditions can be adjusted accordingly.

Further, step S120 is to implement a purification operation including: purifying the product stream P1 that is formed by the Couette-Taylor reactor 1 and contains the cathode material precursor, so as to separate out the cathode material precursor from the product stream P1.

More specifically, the purification operation includes: filtering the product stream P1 to filter out the cathode material precursor, and cleaning and drying the cathode material precursor to obtain a purified cathode material precursor, which is in a powder form, but the present disclosure is not limited thereto.

Further, step S130 is to implement a calcining operation, including: using a high-temperature tubular furnace and filling an oxygen gas into the high-temperature tubular furnace to calcine the purified cathode material precursor, and then a nickel-rich and lithium-rich cathode material is obtained, which can be used as a cathode material for lithium batteries.

In some embodiments of the present disclosure, calcining conditions of the calcining operation include: heating the oxygen gas filled in the high-temperature tubular furnace to a first temperature of 120° C. to 180° C. to heat the cathode material precursor for 1 hour to 3 hours; and then, heating the oxygen gas filled in the high-temperature tubular furnace to a second temperature of 450° C. to 550° C. to heat the cathode material precursor for 5 hours to 7 hours; and then, heating the oxygen gas filled in the high-temperature tubular furnace to a third temperature of 750° C. to 850° C. to heat the cathode material precursor for 11 hours to 13 hours, so as to finally form the nickel-rich and lithium-rich cathode material that can be used as the lithium-ion battery cathode material. However, the calcining operation of the present disclosure is not limited to the above conditions.

It is worth mentioning that in the present embodiment, since the cathode material precursor formed by the Couette-Taylor reaction operation is the hydroxide of an alloy of multi-metal elements and lithium elements, the calcining operation can directly calcine the purified cathode material precursor in the high-temperature tubular furnace, thus eliminating the steps of mixing and ball milling the cathode material precursor with solid lithium salt (e.g., solid lithium hydroxide).

According to the above configuration, the embodiment of the present disclosure uses the Couette-Taylor Taylor reactor to replace a conventional continuous stirred reactor. A co-precipitation method is used to prepare the cathode material precursor. By adjusting the reaction temperature, rotation speed and liquid flow rate, the particle size, crystallinity and specific surface area of the cathode material precursor can be controlled. The method of the embodiment of the present disclosure is suitable for industrial continuous production. In addition, the method of the embodiment of the present disclosure uses the co-precipitation method to introduce the lithium source into the multi-metal precursor, which replaces the conventional method of mixing and grinding to introduce the lithium source, so that the lithium elements can be uniformly dispersed at the atomic level. The method of the embodiment of the present disclosure can omit the steps of mixing and ball milling, and has the advantage of simple manufacturing process.

### BENEFICIAL EFFECTS OF THE EMBODIMENTS

In conclusion, in the method for preparing the lithium-ion battery cathode material provided by the present disclosure, by virtue of “implementing a Couette-Taylor reaction operation including: feeding a first reaction liquid into a Couette-Taylor reactor, in which the first reaction liquid is a multi-metal solution containing: a nickel compound, a cobalt compound, and a manganese compound; feeding a second reaction liquid into the Couette-Taylor reactor to react with the first reaction liquid to form a product stream including a cathode material precursor, in which the second reaction liquid is a lithium source metal solution containing a lithium compound, and the cathode material precursor contains lithium elements,” and “implementing a calcining operation including using a high-temperature tubular furnace to calcine the cathode material precursor separated from the product stream to obtain the lithium-ion battery cathode material,” lithium elements can be uniformly dispersed at an atomic level in the cathode material by introducing the lithium source (i.e., the lithium source metal solution) through the co-precipitation method, thereby reducing a degree of cation mixing and enhancing an orderliness of a layered structure of the cathode material.

In addition, the cathode material has uniform particle size, which can improve battery life and stability. Meanwhile, on the basis of achieving high gram capacitance and good capacitance maintenance rate, the cathode material is also safe.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for preparing a lithium-ion battery cathode material, comprising:
implementing a Couette-Taylor reaction operation including:
feeding a first reaction liquid into a Couette-Taylor reactor; wherein the first reaction liquid is a multi-metal solution containing: a nickel compound, a cobalt compound, and a manganese compound; and
feeding a second reaction liquid into the Couette-Taylor reactor to react with the first reaction liquid, so as to form a product stream including a cathode material precursor; wherein the second reaction liquid is a lithium source metal solution containing a lithium compound, and the cathode material precursor contains lithium elements; and
implementing a calcining operation including using a high-temperature tubular furnace to calcine the cathode material precursor separated from the product stream to obtain the lithium-ion battery cathode material.

2. The method for preparing the lithium-ion battery cathode material according to claim 1, wherein, after the Couette-Taylor reaction operation and before the calcining operation, the method further comprises: implementing a purification operation that includes filtering and drying the product stream to separate out the cathode material precursor in a powder form.

3. The method for preparing the lithium-ion battery cathode material according to claim 1, wherein, in the second reaction liquid, the lithium compound is at least one of lithium hydroxide (LiOH), lithium carbonate (Li₂CO₃), lithium acetate (CH₃COOLi), lithium oxalate (Li₂C₂O₄), lithium sulfate (Li₂SO₄), and lithium nitrate (LiNO₃).

4. The method for preparing the lithium-ion battery cathode material according to claim 1, wherein, in the first reaction liquid, the nickel compound is nickel sulfate (NiSO₄), the cobalt compound is cobalt sulfate (CoSO₄), and the manganese compound is manganese sulfate (MnSO₄).

5. The method for preparing the lithium-ion battery cathode material according to claim 1, wherein, in the second reaction liquid, the lithium compound is lithium hydroxide (LiOH).

6. The method for preparing the lithium-ion battery cathode material according to claim 5, wherein the lithium compound in the second reaction liquid is a source of the lithium elements of the cathode material precursor.

7. The method for preparing the lithium-ion battery cathode material according to claim 6, wherein, in the Couette-Taylor reaction operation, the second reaction liquid regulates a pH value of a reaction mixture including the first reaction liquid and the second reaction liquid; wherein the pH value of the reaction mixture is adjusted to be between 10 and 12.

8. The method for preparing the lithium-ion battery cathode material according to claim 7, wherein, in the Couette-Taylor reaction operation, the second reaction liquid does not contain sodium hydroxide (NaOH).

9. The method for preparing the lithium-ion battery cathode material according to claim 7, wherein the Couette-Taylor reaction operation further includes:
feeding a chelating agent liquid into the Couette-Taylor reactor to mix with the reaction mixture; wherein the chelating agent liquid is an ammonia solution.

10. The method for preparing the lithium-ion battery cathode material according to claim 1, wherein a first reaction liquid flow rate of the first reaction liquid fed into the Couette-Taylor reactor is between 1.5 mL/min and 2.0 mL/min, a second reaction liquid flow rate of the second reaction liquid fed into the Couette-Taylor reactor is between 2.3 mL/min and 3.0 mL/min, and a flow rate ratio between the first reaction liquid flow rate and the second reaction liquid flow rate is between 1:1.2 and 1:2.

11. The method for preparing the lithium-ion battery cathode material according to claim 1, wherein the cathode material precursor formed by the Couette-Taylor reaction operation is a hydroxide of a metal alloy, and the metal alloy includes nickel elements, cobalt elements, manganese elements, and the lithium elements.

12. The method for preparing the lithium-ion battery cathode material according to claim 1, wherein calcining conditions of the calcining operation include filling an oxygen gas into the high-temperature tubular furnace and heating the oxygen gas to a first temperature of 120° C. to 180° C. to heat the cathode material precursor for 1 hour to 3 hours; and then, heating the oxygen gas to a second temperature of 450° C. to 550° C. to heat the cathode material precursor for 5 hours to 7 hours; and then, heating the oxygen gas to a third temperature of 750° C. to 850° C. to heat the cathode material precursor for 11 hours to 13 hours, so as to finally form the lithium-ion battery cathode material.

13. The method for preparing the lithium-ion battery cathode material according to claim 1, wherein, after the Couette-Taylor reaction operation and before the calcining operation, the method does not include steps of mixing and ball milling the cathode material precursor with a solid lithium salt.
